(19) United States
(12) Patent Application Publication
(10) Pub. No.: US 2007/0075800 A1
(43) Pub. Date: Apr. 5, 2007

(54) Device for indivisual control of multiple circuit-unit using single cable and method thereof

(76) Inventor: Sam Hyeon Lee, Seoul (KR)

Correspondence Address: J.C. Patents, Inc., 4 Venture, Suite 250, Irvine, CA, 92618, US

(21) Appl. No.: 10/579,818

(22) PCT Filed: Nov. 18, 2004
(86) PCT No.: PCT/KR04/02990

§ 371 Date: May 16, 2006

(30) Foreign Application Priority Data
Nov. 18, 2003 (KR) 10-2003-0081794
Nov. 18, 2003 (KR) 10-2003-0081795

(51) Int. Cl. H01P 5/12

(52) U.S. Cl. 333/1

(57) ABSTRACT

Disclosed is a control device and method for individually controlling plural circuit-units connected along a single cable. The control device comprises a central unit, a cable emanatintg from the central unit, and plural circuit-units connected to the cable in parallel and each provided with a band pass filter having a frequency band different from those of any other band pass filters provided for the other circuit-units. If the central unit selects a carrier frequency and sends the carrier with a control signal through the cable, the control signal is transmitted only to the selected circuit-unit to control the circuit-unit because the signal does not pass through a band pass filter of a circuit-unit that does not match with the signal in frequency.

### TECHNICAL FIELD

The present invention relates to a control device and method for individually controlling multiple circuit-units using a single cable and in particular to a device and method for individually controlling multiple circuit-units using a single cable, in which each circuit-unit includes a band pass filter (hereinafter, to be refereed as “BPF” and a central unit selects a predetermined frequency and sends a control signal, thereby controlling only a selected circuit-unit without affecting any other circuit-unit which does not match with the selected frequency.

### BACKGROUND ART

In general, a control device for individually controlling plural circuit-units using a cable controls plural circuit-units from a central unit, in which the central unit is connected to each of the circuit-units through one or more cables. Now, conventional control devices for individually controlling plural circuit-units using one or more cables will be described with reference to accompanying drawings.

FIG. 1 is a schematic view showing a conventional device for individually controlling plural circuit-units using plural cables.

The control device includes a central unit 10, plural circuit-units 30 and plural cables 20, in which in the past, the plural cables 20 have been connected to the central unit 10 and each of the plural units 30 through the plural cables 20 as if an octopus spreads its arms, as shown in FIG. 1, so that the control device individually controls the circuit-units 30. Therefore, when controlling a large number of circuit-units 30, there was a problem in that cables 20 get tangled and are difficult to handle due to the volume and weight of the bundle of the cables 20.

Furthermore, although the purchase price of cables 20 is proportional to the number of circuit-units 30, the costs of design, construction, maintenance and repair are proportional to the square of the number of circuit-units because the cables 20 get tangled or tend to be confused with each other, with the result that a lot of costs are expended in order to control a large number of circuit-units 30.

FIG. 2 shows a control unit for controlling various circuit-units, which was developed in order to solve the problem as described above.

Referring to FIG. 2, the control unit individually controls circuit-units 30 using a single cable 20 through digital repeaters 40, respectively. At this time, each of the repeaters 40 has an intrinsic address so that the repeaters 40 can digitally communicate with the central unit 10 to exchange information. Such a solution partially solves the above-mentioned problem. However, this solution requires N number of high-priced repeaters 40, which require large expense and large space.

### DISCLOSURE OF INVENTION

Technical Problem

Therefore, when controlling a large number of circuit-units 30, there was a problem in that cables 20 get tangled and are difficult to handle due to the volume and weight of the bundle of the cables 20.

Furthermore, although the purchase price of cables 20 is proportional to the number of circuit-units 30, the costs of design, construction, maintenance and repair are proportional to the square of the number of circuit units because the cables 20 get tangled or tend to be confused with each other, with the result that a lot of costs are expended in order to control a large number of circuit-units 30.

At this time, each of the repeaters 40 has an intrinsic address so that the repeaters 40 can digitally communicate with the central unit 10 to exchange information. Such a solution partially solves the above-mentioned problem. However, this solution requires N number of high-priced repeaters 40, which require large expense and large space.

Technical Solution

Therefore, the present invention has been made in view of the above-mentioned problems, and it is an object of the present invention to provide a control device for individually controlling plural circuit-units using a single cable, in which along the cable emanating from a central unit, plural circuit-units are connected in parallel and each provided with a band pass filter having a frequency band different from those of any other band pass filters provided for the other circuit-units.

According to an aspect of the present invention, there is provided a control device for individually controlling plural circuit-units using a single cable, including: a central unit for transmitting frequency signals of different frequency channels; plural circuit-units each provided with a band pass filter having a frequency band different from those of any other band pass filters provided for the other circuit-units; and a cable connected between the central unit and the plural circuit-units to transfer the frequency signals from the central unit to the plural circuit-units.

Each of the band pass filters has a voltage threshold circuit which has a diode section, in which at least one forward diode and at least one reverse diode are connected in parallel to each other.

In addition, each of the band pass filters includes a detection unit for detecting an AM signal if a signal passing through the corresponding band pass filter is an AM signal. At this time, the detection unit includes at least one diode, which serves as a voltage threshold circuit for providing a voltage threshold value for the corresponding band pass filter.

outputting a frequency signal, a ground line, and a return line, wherein amongst the frequency channels, the highest frequency channel is transmitted to the return line. The cable is connected with an existing power line so that electric power and the frequency signals are transmitted through the power line. A switch section controlled by the central unit is included in the midway of the power line in the case in which the cable is connected to the power line.

In transmitting the frequency signals of the different frequency channels, the central unit divides time into time periods assigned to the different frequency channels and sequentially transmits the frequency signals through the different frequency channels according to the divided time periods (serial delivery). Alternatively, the central unit may overlappingly and simultaneously transmits the frequency signals to the plural circuit-units through different frequency channels (overlapping delivery).

In addition, the central unit may send only one frequency value as a frequency signal to be transmitted to a predetermined circuit-unit, and then send the frequency signal to the corresponding circuit-unit using single resonance only when the frequency value matches with a frequency band of a band pass filter corresponding to the predetermined circuit-unit. Alternatively, the central unit may send two or more frequency values as a predetermined frequency signal to be transmitted to a predetermined circuit-unit, and then send the predetermined frequency signal to the predetermined circuit-unit using multiple resonance only when all the frequency values match with a frequency band of a band pass filter corresponding to the predetermined circuit-unit.

In addition, awarding to another aspect of the present invention, there is provided a control device for individually controlling plural circuit-units using a single cable, including: a central unit for transmitting frequency signals of different frequency channels to and receiving signals from circuits; plural circuit-units each provided with a band pass filter having a frequency band different from those of any other band pass filters provided for the other circuit-units, wherein each of the circuit-units selectively receives a frequency signal and sends signal information concerning a load included therein to the central unit; and a cable connected between the central unit and the plural circuit-units to transfer the frequency signals from the central unit to the plural circuit-units and to transfer the signal information from the plural circuit-units to the central unit.

At this time, the cable includes a frequency signal output line for outputting the frequency signals to be transmitted from the central unit to the circuit-units, a ground line, and at least one signal line for transferring signal information from the circuit-units to the central unit. In addition, each of the circuit-units may include a 4-probe method circuit. At this time each of the circuit units may include a switch.

Furthermore, the central unit may send only one frequency value as a frequency signal to be transmitted to a predetermined circuit-unit, and then send the frequency signal to the predetermined circuit-unit using single resonance only when the frequency value matches with a frequency band of a band pass filter corresponding to the predetermined circuit-unit. Alternatively, the central unit may send two or more frequency values as a predetermined frequency signal to be transmitted to a predetermined circuit-unit, and then send the predetermined frequency signal to the predetermined circuit-unit using multiple resonance only when all the frequency values match with a frequency band of a band pass filter corresponding to the predetermined circuit-unit.

According to another aspect of the present invention, there is provided a method for individually controlling plural circuit-units using a single cable, wherein: (a) a central unit transmits, through a cable, frequency signals of different frequency channels to plural circuit-units each provided with a band pass filter having a frequency band different from those of any other band pass filters provided for the other circuit-units; (b) the frequency signals are transferred to the band pass filters; and (c) at least one of the circuit-units receives a frequency signal passing through the corresponding band pass filter.

In addition, step (b) includes step of blocking the frequency signals if the voltages of the frequency signals are below a predetermined voltage threshold value so as to improve the cut-off characteristics of the band pass filters, and step (c) includes step of detecting an AM signal if the frequency signal passing the corresponding band pass filter is an AM signal.

Furthermore, the cable includes a frequency signal output line for outputting a frequency signal, a ground line, and a return line, wherein the highest frequency channel is transmitted to the return line through the competition of the frequency channels. In addition, in step (a) the cable is connected with an existing power line so that electric power and the frequency signals are transmitted through the power line.

According to the present invention, in transmitting the frequency signals of the different frequency channels in step (a) time is divided into time periods assigned to the different frequency channels and the frequency signals are sequentially transmitted one by one through the different frequency channels according to the divided time periods (serial delivery). Alternatively, the frequency signals may be overlappingly and simultaneously transmitted to the plural circuit-units through different frequency channels (overlapping delivery).

It is possible that only one frequency value is sent as a frequency signal to be transmitted to a predetermined circuit-unit, and then the frequency signal is sent to the predetermined circuit-unit using single resonance only when the frequency value matches with a frequency band of a band pass filter corresponding to the predetermined circuit-unit. Alternatively, it is also possible that two or more frequency values are sent as a predetermined frequency signal to be transmitted a predetermined circuit-unit, and then the predetermined frequency signal is sent to the predetermined circuit-unit using multiple resonance only when all the frequency values match with a frequency band of a band pass filter corresponding to the predetermined circuit-unit.

According to still another aspect of the present invention, there is provided a method for individually controlling plural circuit-units using a single cable, wherein: (a) a central unit transmits, through a cable, frequency signals of different frequency channels to plural circuit-units each provided with a band pass filter having a frequency band different from those of any other band pass filters provided for the other circuit-units; (b) the frequency signals transmitted to the band pass filters; (c) at least one circuit-unit receives a frequency signal passing through corresponding one of the band pass filters; and (d) the at least one circuit-unit transmits an information signal concerning a load included therein to the central unit through the cable connected the central unit. At this time, in step (d) the at least one circuit-unit selects a signal line for sending the information signal using a switch.

Meanwhile, it is possible that in step (a) only one frequency value is sent as a frequency signal to be transmitted to a predetermined circuit-unit, and then the frequency signal is sent to the circuit-unit using single resonance only when the frequency value matches with a frequency band of a band pass filter corresponding to the predetermined circuit-unit. Alternatively, it is also possible that in step (a) two or more frequency values are sent as a predetermined frequency signal to be transmitted a predetermined circuit-unit, and then the predetermined frequency signal is sent to the predetermined circuit-unit using multiple resonance only when all the frequency values match with a frequency band of a band pass filter corresponding to the predetermined circuit-unit.

Advantageous Effects

As can be seen from the foregoing, according to the inventive device and method for individually controlling plural circuit-units using a single cable, a central unit and plural circuit-units are connected to a cable by way of band pass filters having different frequency bands, respectively, rather than directly connected to the cable, with the result that there is an advantage in that the central unit can selectively access and control the circuit units by differentiating frequency channels.

### BRIEF DESCRIPTION OF THE DRAWINGS

The foregoing and other objects, features and advantages of the present invention will become more apparent from the following detailed description when taken in conjunction with the accompanying drawings in which:

FIGS. 1 to 2 schematically show conventional control device for controlling plural circuit-unit using one or more cables;

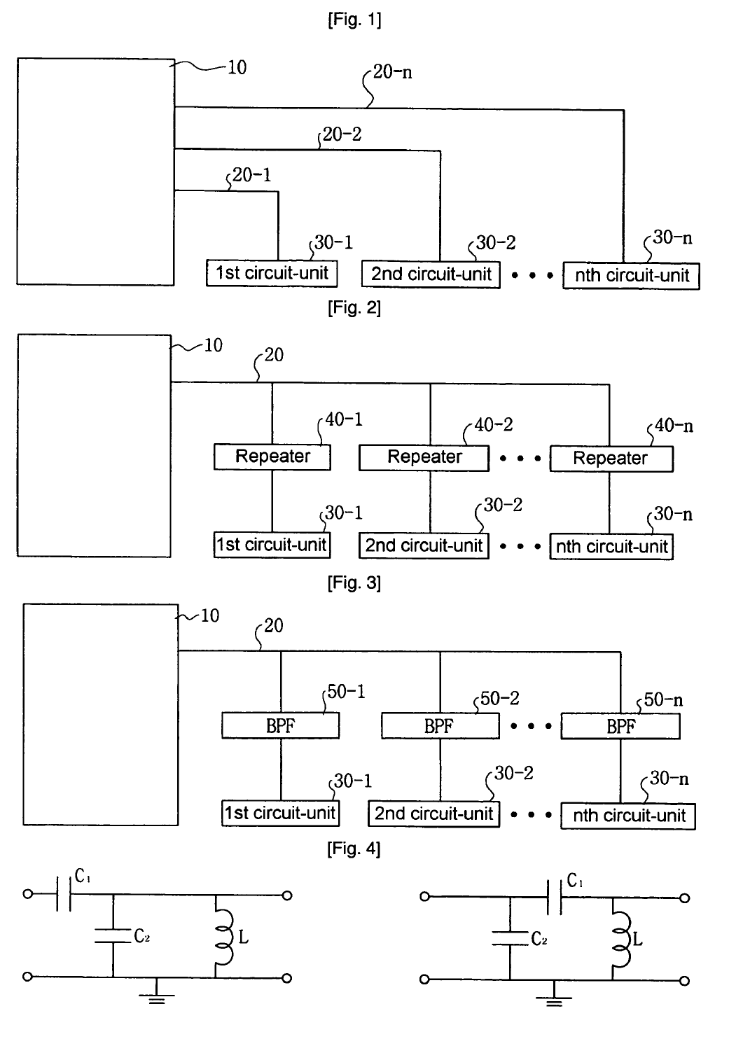

FIG. 3 schematically shows the inventive control device for individually controlling plural circuit-units using a single cable;

FIGS. 4 to 6 show band pass filter circuits included in the present invention and frequency characteristics thereof;

FIGS. 7 to 8 show a band pass filter including a current detection unit and a frequency characteristic thereof;

FIGS. 9 to 11 are a view for describing a method of enhancing a channel density using a method of competitive connection;

FIGS. 12 to 13 show circuit diagrams of double resonance and triple resonance;

FIGS. 14 to 15 show an arrangement of an interphone system awarding to an embodiment of the present and a circuit diagram thereof;

FIGS. 16 to 18 are views for describing a method of overlappingly sending frequency signals emanating from a central unit to a power line, a method of turning on/off a household electric appliance from a central unit, and a method of employing an existing household electric appliance in home-automation, respectively;

FIGS. 19 to 20 show an arrangement of a temperature measurement system according to another embodiment of the present invention and a circuit diagram thereof; and

FIG. 21 is a view for describing a method of receiving a signal using a solenoid switch.

### BEST MODE FOR CARRYING OUT THE INVENTION

Now, the preferred embodiments of the present invention will be described in detail with reference to the accompanying drawings.

Components of the present invention same with those of the prior art described will be indicated by same reference numerals as those used in describing the prior art.

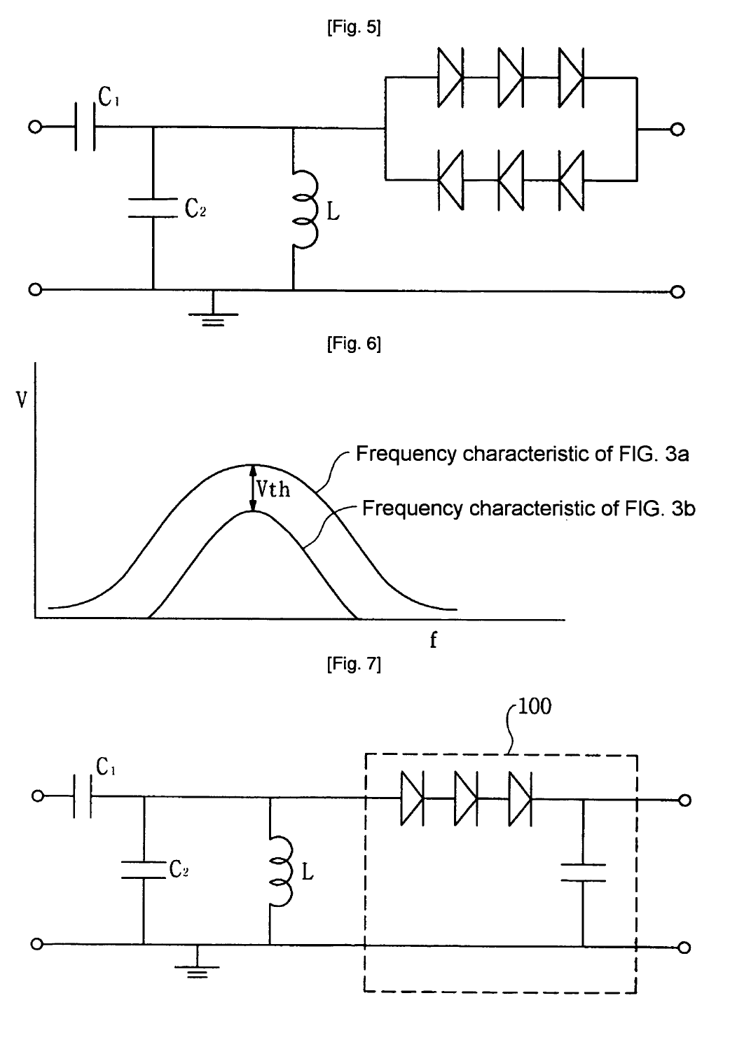

As shown in FIG. 3, the present invention includes a central unit 10, a cable 20 and plural circuit units 30 each equipped with a band pass filter 50. The plural circuit-units 30 are connected in parallel along the cable 20 emanating from the central unit 10 like plural Christmas decorative lights.

The cable may include at least two insulated conducting wires, one of which is a frequency signal output line (not shown) and the other of which is a ground line (not shown). In addition, the cable may branch off into two or more or be arranged like a net.

Now, the operation performed by the present invention described above to individually control various circuit-units using a single cable is described in detail.

First, a central unit 10 is connected to individual circuit-units 30 through a cable 20 consisting of two conducting wires like a coaxial cable or a power line in order to send frequency signals to the circuit-units 30. The plural circuit units 30 are connected to the cable 20 in parallel to each other by way of band pass filters 50.

The frequency bands of the band pass filters 50 each provided at an entrance of one of the circuit-units 30 are set to be different from each other, so that if the central unit 10 send a signal with a frequency, the signal will pass through only a band pass filter 50 matching with the frequency to operate or control a corresponding circuit-unit without consuming its energy to other circuit-units 30. Because a circuit-unit to be supplied with a frequency signal from the central unit 10 among the plural circuit-units 30 are determined by the frequency, the circuit-units are distinguished from each other the frequency channels assigned thereto.

For delivering signals, there are two methods, including a serial delivery method and an overlapping delivery method. In the serial delivery method, time is divided wording to multiple channels and signals are sequentially transmitted through corresponding channels of the multiple channels. In the overlapping delivery method, multiple frequency signals are overlappingly transmitted through the cable 20, so as to simultaneously and independently controlling the multiple circuits-units 30. The overlapping delivery method is more effective than the serial delivery method in the aspect of signal delivery but requires plural frequency oscillators for the central unit. Therefore, either of the two methods may be selected and applied depending on the conditions. The inventive control device can select and apply one of the serial delivery and overlapping delivery depending on the situation.

In addition, although a signal to be sent to a designated circuit-unit may be a digital signal which turns on/off a signal, it is also possible to transmit an analog signal such as a sound signal or an image signal using amplitude modulation or frequency modulation.

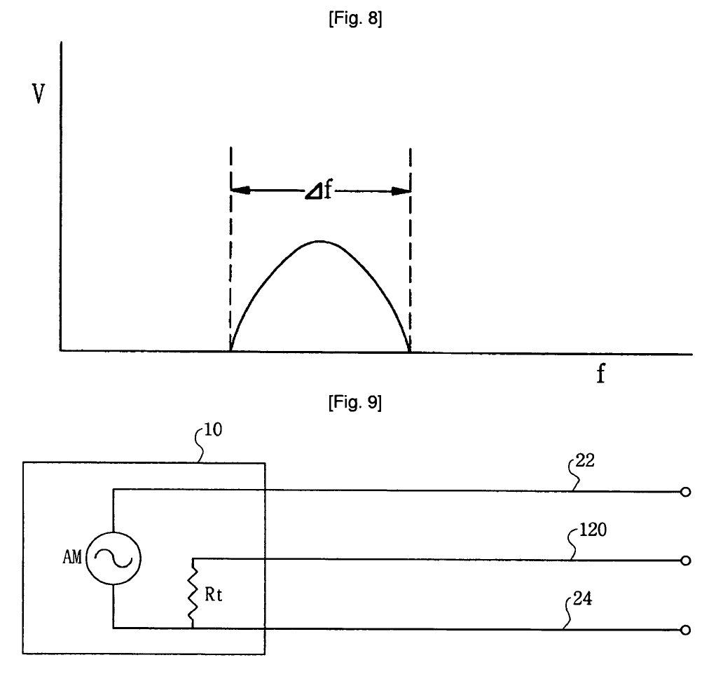

FIG. 4 shows a band pass filter circuit included in the present invention as an embodiment, FIG. 5 shows a band pass filter circuit provided with a voltage threshold, and FIG. 6 shows frequency characteristics thereof.

FIG. 4 shows an impedance-matched LC resonance circuit. Because it is well-known in the art that such an LC resonance circuit is operated as a band pass filter, description thereof is omitted. Such a circuit can be easily implemented because it is inexpensive and simple in construction. However, because such a resonance circuit does not have a good frequency characteristic as a band pass filter 50, the curve of the frequency characteristic does not sharply drop at the opposite ends of the band. That is, because the frequency characteristic does not sufficiently drop in the outside of an intended band, adjacent channels are not completely separated from each other.

Therefore, a technique is required which renders a carrier frequency to operate an intended channel without affecting other channel at all even if a band pass filter 50 having a poor frequency characteristic. In this regard, the present invention employs a voltage threshold circuit located just after the band pass filter 50 to cut off a signal below a predetermined level.

FIG. 5 shows a circuit in which the above-mentioned technical idea of the present invention is implemented, wherein a simple amplitude filter limits the voltage threshold of diodes. Because a predetermined level of voltage drop (about 0.6 V for each diode) is occurred when forward current of the diodes flows, it is possible to set a voltage threshold value (Vₜₕ) by selecting the number of diodes to be employed. Furthermore, because the level of current flowing to an output terminal is sufficiently low in order to prevent the drop of Q value in the LC resonance circuit of FIG. 5, it may be required to use an amplifier with high impedance or a buffer between the output stage of the LC resonance circuit and the voltage threshold circuit.

FIG. 6 shows the frequency characteristics of the filters shown in FIGS. 4 and 5. As can be seen from the drawing, the filter of FIG. 5 can be usefully employed because it can desirably cut off a signal beyond an intended frequency area although the signal suffers from a voltage drop of Vth while passing through the diodes.

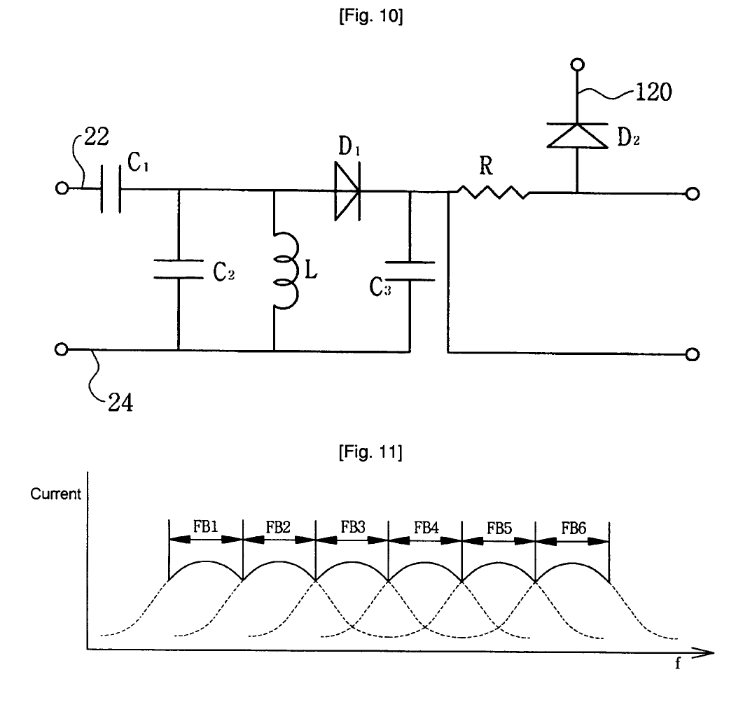

Meanwhile, if a circuit-unit receives an AM signal, it is necessary to detect the frequency signal after passing through the band pass filter 50. FIG. 7 shows a band pass filter circuit provided with a detection unit and FIG. 8 shows the frequency characteristic of the circuit shown in FIG. 7.

Referring to FIG. 7, the circuit includes a detection unit 100 including plural diodes and a capacitor. If the circuit of FIG. 7 is employed, a frequency gap should be provided between adjacent two channels to be not less than Δf of FIG. 8. However, if the frequency gap exceeds Δf, it is not efficient in the standpoint of channel density. Accordingly, it is required to find a method for improving channel density. Now, description is made in terms of a method of improving channel density using competitive connection and a method of improving channel density using dual resonance.

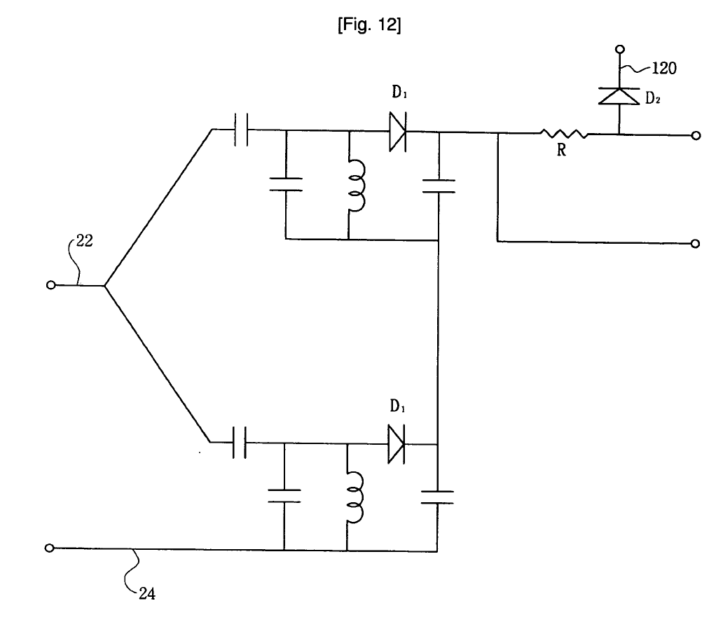

FIGS. 9 to 11 are view for describing the method of improving competitive connection, in which FIG. 9 shows lines connected to the cable 20, FIG. 10 shows the circuit diagram employing the competitive connection method, and FIG. 11 shows the frequency characteristic of the circuit shown in FIG. 10.

In the case of AM signal, a return line 120 is added to the cable 20 beyond a frequency signal output line 22 and a ground line 24. The circuit complicated by using the three lines is shown in FIG. 10. A diode D₂ blocks reverse current. Therefore, amongst plural channels, current flows through only the diode D₂ of the channel having the highest detected voltage passes current but does not flow through the diodes D₂ of the other channels do not pass current at all because reverse voltage is applied across the diodes D2 of the other channels. That is, the channels enter into competition and the channel having the highest voltage will exclusively possess the return line 120.

FIG. 11 shows the frequency characteristics of LC resonance circuits of individual circuit-units, and the profile of current finally flowing through the resistor Rₜ through the competition between the channels. Referring to FIG. 11, in the frequency band of FB1, channel 1 exclusively possesses the return line 120, and in the frequency band of FB2, channel 2 exclusively possesses the return line 120. It can be seen that the frequencies are well spaced from each other and the frequency bands are well exclusively divided even if the frequency gap Δf between two adjacent channels is subsequently narrowly set as compared with that of FIG. 8. Therefore, this method is useful in improving channel density; if this method is employed, three or more times of channels can be provided within a given frequency band as compared to the case this method is not employed.

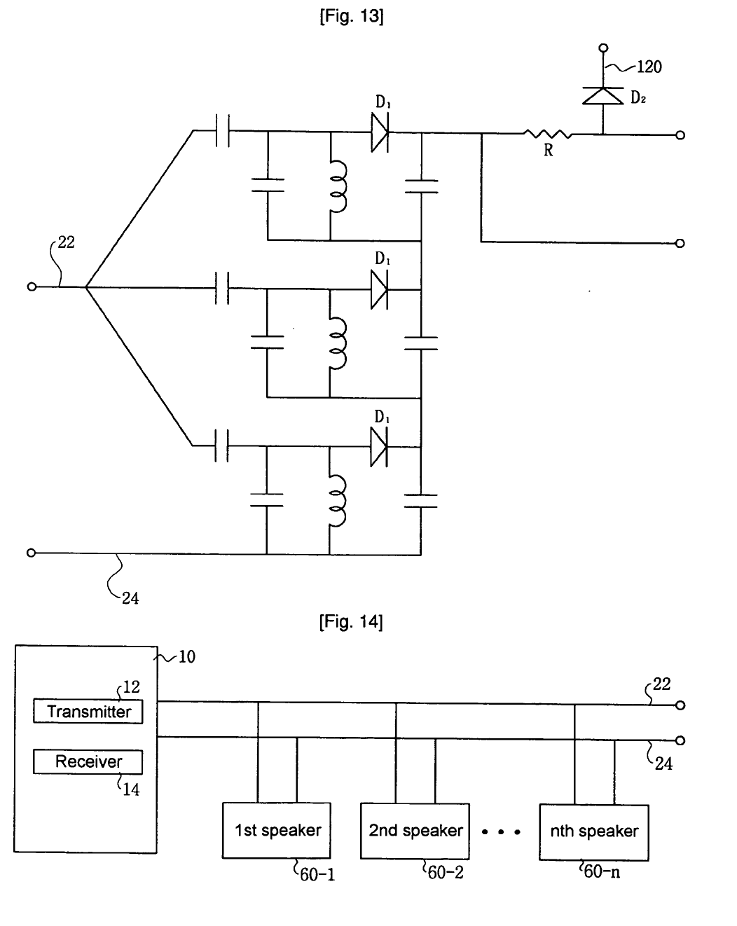

In the case of employing the afore-mentioned competitive connection method, assuming that it is possible to provide N channels within a given frequency band using single resonance, it is possible to provide N(N−1) channels within the given frequency band if double resonance is used as shown in FIG. 12. This can be said as an epoch-making solution because N(N−1)=9900 if N=100. If two signals of different frequencies f1 and f2 are overlappingly sent through the frequency signal output line 22, a circuit-unit matching with both of the two frequencies f1 and f2 of double resonance will possess the return line because its output voltage is substantially higher than that of a circuit-unit matching with one of the two frequencies or a circuit-unit not matching with any of the two frequencies. FIG. 13 shows a circuit employing triple resonance, in which three signals of different frequencies are overlappingly sent. In such a case, the number of possible channels is N(N−1)(N−2). In these manners, the double resonance or triple resonance method makes it possible to provide a great number of channels within a given frequency bandwidth.

Mode for the Invention

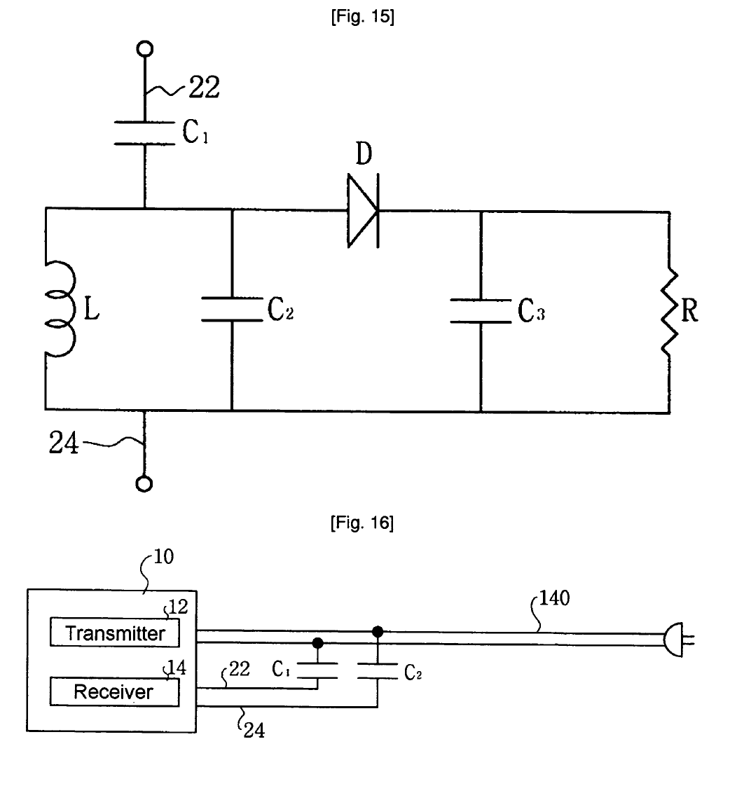

FIG. 14 shows a schematic constructional view of an interphone which employs the inventive control device for individually controlling plural circuit-units, and FIG. 15 shows a circuit diagram of the interphone shown in FIG. 14.

As shown in FIG. 14, the inventive control device connects plural speakers 60 located at different places with a central unit 10 and a cable 20, so that sound can be transferred to only one speaker among the plural speakers 60. In the circuit of FIG. 15, the part consisting of capacitors C₁ and C₂ and a coil L is an impedance-matched resonance circuit and a diode D and a capacitor C₃ transmit a detected sound signal to a speaker 60.

In this case, if the serial delivery method is employed, the sound can be transmitted to only one speaker at a time, and if the overlapping delivery method is employed, independent signals can be transmitted to plural speakers at once. The load indicated by R in FIG. 15 may be a light, a neon sign, an LED, a solenoid switch or a motor rather than a speaker. For example, if a solenoid switch is provided as the load R, it is possible to turn on/off a heating switch, an electric rice cooker, a washing machine, a light, a motor-operated window, a motor operated blind, or the like from a central unit as home automation. In addition, if this technical idea is employed, it is possible to use a power line without installing a separate in-door signal transmission line. Meanwhile, the solenoid switch is merely an example to be employed in the invention for switching operation and any means can be employed if it can perform such switching operation.

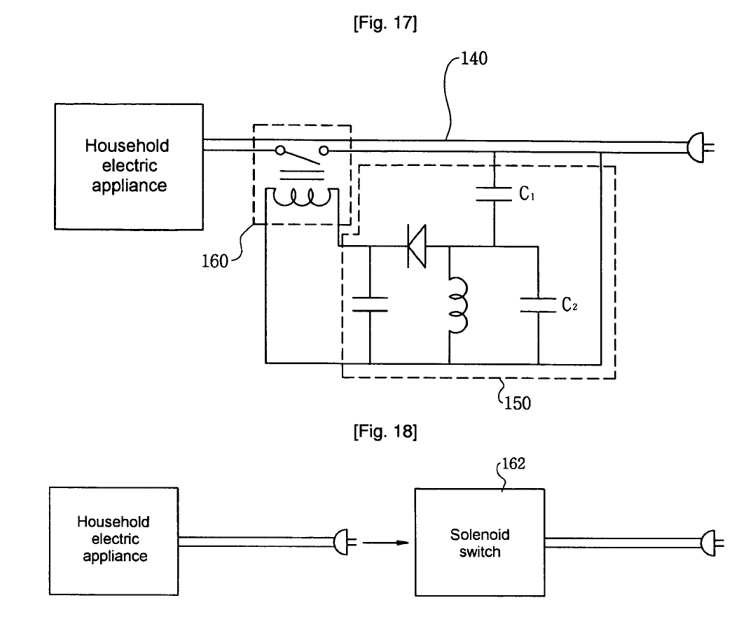

FIG. 16 shows a method of overlappingly sending frequency signals emanating from a central unit, FIG. 17 shows a method of turning on/off a household electric appliance, and FIG. 18 shows a method of utilizing an existing household electric appliance in home automation.

As shown in FIG. 16, the frequency signal cables 22, 24 extending from the central unit 10 are connected to a power line 140 via high pass filters for blocking 60 Hz. At this time, because the signal has a frequency in a kHz range, the signals are overlappingly supplied to a wall outlet. In addition, if a household electric appliance is connected to the power line 140 regardless of where the electric appliance is positioned, the frequency signals are supplied as well as electric power along a cord.

If a solenoid switch 160 operated by the above-mentioned frequency signal is provided as shown in FIG. 17, it is possible to turn on/off a household electric appliance from the central unit. At this time, if it is not possible to operate the solenoid switch 160 with the output of the frequency only due to a large capacitance of the household electric appliance, it is possible to operate the solenoid switch after a transistor switch 150 is operated. In addition, in order to prevent a frequency signal introduced into a power line of a house from operating a household electric appliance of a neighboring house, it is necessary to provide a low pass filter (LPF) on a main power line so as to block the exit and entrance of a frequency signal in a kHz range.

The home automation technique employing the inventive control device has an advantage in that an existing household electric appliance can be utilized in a simple manner as shown in FIG. 18: it is sufficient if an inexpensive and small-sized solenoid switch 162 controlled from the central device is made and then a plug of a power line is inserted into the solenoid switch 162. In addition, because the frequency of a frequency signal is lower than that of a digital signal, the signal is less damped when it is transmitted through a power line.

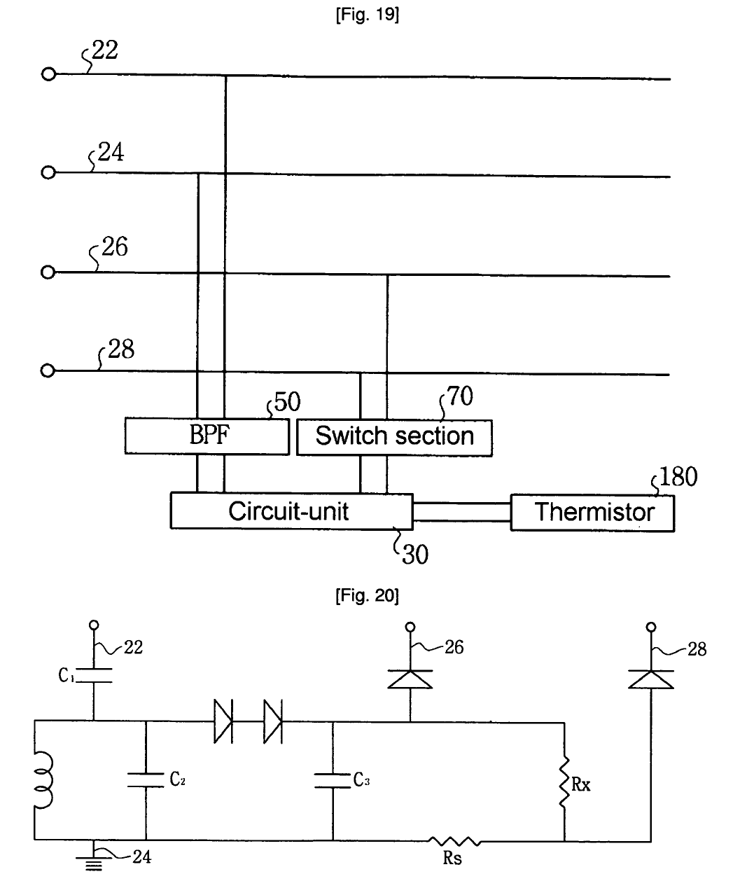

FIGS. 19 and 20 shows another embodiment of the present invention, in which FIG. 19 shows a constructional view of a temperature measuring system provided with the inventive control device and FIG. 20 shows a circuit diagram of the temperature measuring system shown in FIG. 19.

Such a temperature measuring system can be used in monitoring a fire, leakage from a gas pipe, leakage from a gasket of a steam valve of a power plant, or the like by monitoring the temperature distribution at real-time. The temperature measuring system uses a cable 20 consisting of four conducting wires as shown in FIG. 19 so as to designate a circuit-unit 30 from the central unit 10 and to receive a signal from the designated circuit-unit 30. The four conducting wires form a frequency signal output line 22, a ground line 24, a first signal line 26 and a second signal line 28, and the circuit shown in FIG. 20 is additionally provided with a 4-probe method circuit in a band pass filter 50 and a detection unit 100.

When the intensity of a frequency signal is made to be constant, the 4-probe method circuit allows current to flow through a voltage divider consisting of Rₓ and Rₛ as C₃ serves as a power source of current. In addition, the total voltage V₁ and the divided voltage V₂ are measured in the central unit through the first signal line 26 and the second signal line 28, respectively. At this time, the total V₁ will be fluctuated even if a frequency signal is supplied from the central unit 10 with a stable power, because the signal is damped on its way. However, if V₁ and V₂ are measured at once, it is possible to calculate the resistance Rₓ of a thermistor 180 because the standard resistance Rₛ is predetermined. In addition, it is possible to precisely measure the voltages without a drop of voltage because no current flows through the first signal line 26 and the second signal line 28 if the input impedance of a resistance measuring device is increased.

In the circuit of FIG. 20, all the circuit-units are provided with diodes D₁ ,D₂ so as to isolate the circuit-units from the operation of a selected circuit-unit. Due to these diodes, both of the first signal line 26 and the second signal line 28 are exclusively possessed by the selected signal unit, and reverse voltage is applied to the remaining circuit-units, thereby blocking signals. However, although signals V₁, V₂ supper from a drop of potential while passing through the diodes D₁, D₂, respectively. This can be reflected to the calculation thereof and will not cause any problem.

Because the diodes D1, D2 competitively connect channels to a signal line, the principle of improving channel density as described above can be naturally applied to this embodiment. Furthermore, it is also possible to employ the above-mentioned double resonance or triple resonance method in a temperature measuring system.

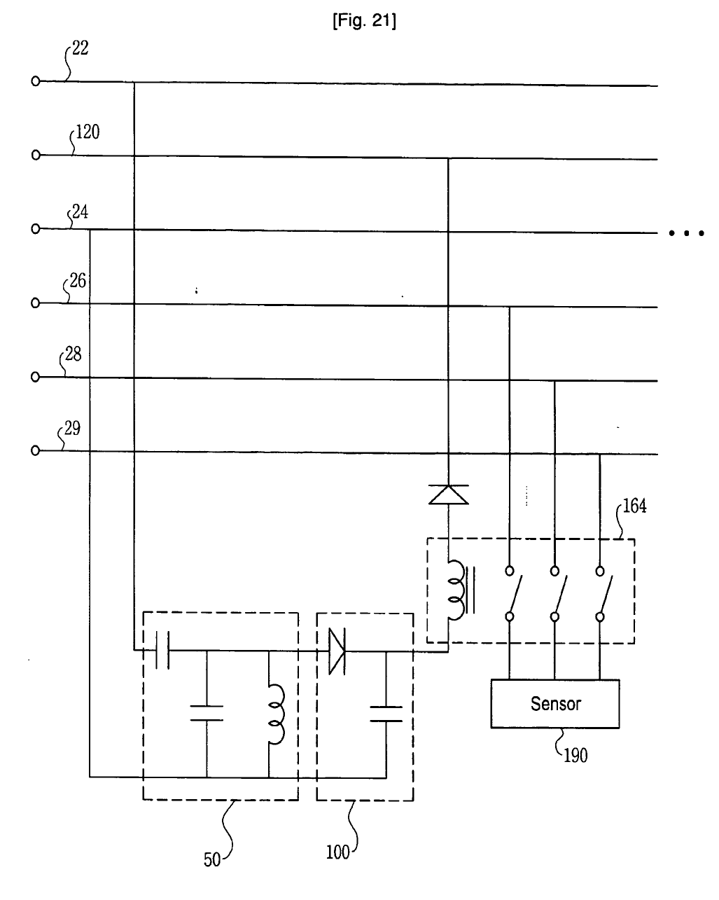

FIG. 21 shows a method of receiving a signal using a solenoid switch.

As shown in FIG. 21, the signal having passed through the band pass filter 50 and the detection unit 100 is used for switching a signal of a sensor to a signal line. FIG. 21 shows three signal lines (i.e., a first signal line 26, a second signal line 28 and a third signal line 29). In this case, because the solenoid switch is activated by a serially delivered signal, the central unit can clearly determine which sensor has emitted the signal delivered to a signal line and process the signal.

The method for accumulating signals using a solenoid switch can be conveniently used in a train, a vessel, an airplane and a vehicle when it is needed for a central unit to control: temperatures of various parts or areas; levels of various liquids such as lubricant oil, gasoline, engine oil, anti-freezing solution and washing solution; voltage of a battery; a distance measuring device needed for the rear guard; and a switch for calling a member of the crew.

### INDUSTRIAL APPLICABILITY

As can be seen from the foregoing, awarding to the inventive device and method for individually controlling plural circuits units using a single cable, a central unit and plural circuits-units are connected to a cable by way of band pass filters having different frequency bands, respectively, rather than directly connected to the cable, with the result that there is an advantage in that the central unit can selectively access and control the circuit-units by differentiating frequency channels.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A control device for individually controlling plural circuit-units using a single cable, comprising:
a central unit for transmitting frequency signals of different frequency channels;
plural circuit-units each provided with a band pass filter having a frequency band different from those of any other band pass filters provided for the other circuit-units; and
a cable connected between the central unit and the plural circuit-units to transfer the frequency signals from the central unit to the plural circuit-units.

2. The control device as claimed in claim 1, wherein each of the band passes filters has a voltage threshold circuit.

3. The control device as claimed in claim 2, wherein the voltage threshold circuit has a diode section, in which at least one forward diode and at least one reverse diode are connected in parallel to each other.

4. The control device as claimed in claim 1, wherein each of the band pass filters has a detection unit for detecting an AM signal if a signal passing through the corresponding band pass filter is an AM signal.

5. The control device as claimed in claim 4, wherein the detection unit comprises at least one diode, which serves as a voltage threshold circuit for providing a voltage threshold value for the corresponding band pass filter.

6. The control device as claimed in claim 1, wherein the cable comprises a frequency signal output line for outputting a frequency signal, a ground line, and a return line, wherein amongst the frequency channels, the highest frequency channel is transmitted to the return line.

7. The control device as claimed in claim 1, wherein the central unit divides time into time periods assigned to the different frequency channels and sequentially transmits the frequency signals through the different frequency channels according to the divided time periods.

8. The control device as claimed in claim 1, wherein the central unit overlappingly and simultaneously transmits the frequency signals to the plural circuit-units through different frequency channels.

9. The control device as claimed in claim 1, the cable is connected with an existing power line so that electric power and the frequency signals are transmitted through the power line.

10. The control device as claimed in claim 9, wherein a switch section controlled by the central unit is included in the midway of the power line in the case in which the cable is connected to the power line.

11. The control device as claimed in claim 1, wherein the central unit sends only one frequency value as a frequency signal to be transmitted to a predetermined circuit-unit, and then sends the frequency signal to the predetermined circuit-unit using single resonance only when the frequency value matches with a frequency band of a band pass filter corresponding to the predetermined circuit-unit.

12. The control device as claimed in claim 9, wherein the central unit sends only one frequency value as a frequency signal to be transmitted to a predetermined circuit-unit, and then sends the frequency signal to the predetermined circuit-unit using single resonance only when the frequency value matches with a frequency band of a band pass filter corresponding to the predetermined circuit-unit.

13. The control device as claimed in claim 1, wherein the central unit sends two or more frequency values as a predetermined frequency signal to be transmitted to a predetermined circuit-unit, and then sends the predetermined frequency signal to the circuit-units using multiple resonance only when all the frequency values match with a frequency band of a band pass filter corresponding to the predetermined circuit-unit.

14. The control device as claimed in claim 9, wherein the central unit sends two or more frequency values as a predetermined frequency signal to be transmitted to a predetermined circuit-unit, and then sends the predetermined frequency signal to the circuit-units using multiple resonance only when all the frequency values match with a frequency band of a band pass filter corresponding to the predetermined circuit-unit.

15. A control device for individually controlling plural circuit-units using a single cable, comprising:
a central unit for transmitting frequency signals of different frequency channels to and receiving signals from circuit-units;
plural circuit-units each provided with a band pass filter having a frequency band different from those of any other band pass filters provided for the other circuit-units, wherein each of the circuit-units selectively receives a frequency signal and sends signal information concerning a load included therein to the central unit; and
a cable connected between the central unit and the plural circuit-units to transfer the frequency signals from the central unit to the plural circuit-units and to transfer the signal information from the plural circuit-units to the central unit.

16. The control device as claimed in claim 15, wherein the cable comprises a frequency signal output line for outputting the frequency signals to be transmitted from the central unit to the circuit-units, a ground line, and at least one signal line for transferring signal information from the circuit-units to the central unit.

17. The control device as claimed in claim 15, wherein each of the circuit-units comprises a 4-probe method circuit.

18. The control device as claimed in claim 15, wherein each of the circuit-units comprises a switch.

19. The control device as claimed in claim 15, wherein the central unit sends only one frequency value as a frequency signal to be transmitted to a predetermined circuit-unit, and then sends the frequency signal to the predetermined circuit-unit using single resonance only when the frequency value matches with a frequency band of a band pass filter corresponding to the predetermined circuit-unit.

20. The control device as claimed in claim 15, wherein the central unit sends two or more frequency values as a predetermined frequency signal to be transmitted to a predetermined circuit-unit, and then sends the predetermined frequency signal to the circuit-units using multiple resonance only when all the frequency values match with a frequency band of a band pass filter corresponding to the predetermined circuit-unit.

21-35. (canceled)
